(19) United States
(12) Patent Application Publication
(10) Pub. No.: US 2025/0012233 A1
(43) Pub. Date: Jan. 9, 2025

(54) GAS TURBINE ENGINES COMPRISING PITCHED NOSE SPLITTER STRUCTURES AND AIRCRAFT COMPRISING THE SAME

(71) Applicant: HONEYWELL INTERNATIONAL INC., Charlotte, NC (US)

(72) Inventors: Hasham Chougule, Bangalore (IN); Shripad Thakur, Bangalore (IN); Kaustubh Mohta, Bangalore (IN); John Gunaraj, Phoenix, AZ (US); David Hanson, Phoenix, AZ (US); Michael Barton, Phoenix, AZ (US); Mahmoud Mansour, Phoenix, AZ (US)

(73) Assignee: HONEYWELL INTERNATIONAL INC., Charlotte, NC (US)

(21) Appl. No.: 18/452,748

(22) Filed: Aug. 21, 2023

(30) Foreign Application Priority Data
Jul. 7, 2023 (IN) 202311045872

(51) Int. Cl. F02K 1/40; F02C 3/04

(52) U.S. Cl. CPC F02K 1/40; F02C 3/04

(57) ABSTRACT

Gas turbine engines are provided that include an annular splitter nose structure configured to impinge an accelerated air stream within the gas turbine engine and separate the accelerated air stream into a primary air stream directed into a core duct and a secondary air stream directed into a bypass duct. The splitter nose structure may include a leading edge that is pitched radially outward relative to a rotational axis of the gas turbine engine at a pitch angle of between about 0.5 and 20 degrees. The splitter nose structure may include an irregular cross-sectional shape.

### CROSS-REFERENCE TO RELATED APPLICATION

This application claims priority to India Provisional Patent Application No. 20/231,1045872, filed Jul. 7, 2023, the entire content of which is incorporated by reference herein.

### TECHNICAL FIELD

The present invention generally relates to gas turbine engines, and more particularly relates to a splitter nose structure for a gas turbine engine having an irregular, elliptical-like cross-sectional shape with a pitched leading edge.

### BACKGROUND

Gas turbine engines may be employed to power various devices. For example, a gas turbine engine may be employed to power a mobile platform, such as an aircraft. Generally, gas turbine engines have a fan that produces an accelerated air stream that is split into a primary air stream within a core duct and secondary air stream within a bypass duct downstream of the fan. The core duct directs the primary air stream to a compressor section, a combustion section, and a turbine section of the gas turbine engine. The bypass duct directs the secondary air stream to an outlet.

The accelerated air stream is split into the primary air stream and the secondary air stream by impinging an annular splitter nose structure. As the accelerated air stream impinges on a leading edge of the splitter nose structure, aerodynamic losses occur that may have a significant impact on the performance of the compressor section.

Hence, there is a need for systems and methods for promoting efficient operation of a gas turbine engine, particularly relating to reducing aerodynamic losses associated with the annular splitter nose structure. Furthermore, other desirable features and characteristics of the present invention will become apparent from the subsequent detailed description and the appended claims, taken in conjunction with the accompanying drawings and the foregoing technical field and background.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A gas turbine engine is provided that comprises a fan section that includes a rotor having a rotor hub rotatable about a rotational axis and a fan having a plurality of fan blades extending from the rotor hub and annularly spaced about the rotational axis, wherein rotation of the rotor hub and the fan blades extending therefrom produces an accelerated air stream, an annular splitter nose structure downstream of the fan configured to impinge the accelerated air stream and separate the accelerated air stream into a primary air stream and a secondary air stream, a core duct downstream of the splitter nose structure configured to receive and direct the primary air stream to a compressor section, a combustion section, and a turbine section, and a bypass duct downstream of the splitter nose structure configured to receive and direct the secondary air stream to an outlet. The splitter nose structure comprises a leading edge that is pitched radially outward relative to the rotational axis of the rotor hub at a pitch angle of between about 0.5 and 20 degrees.

A gas turbine engine is provided that comprises a fan section that includes a rotor having a rotor hub rotatable about a rotational axis and a fan having a plurality of fan blades extending from the rotor hub and annularly spaced about the rotational axis, wherein rotation of the rotor hub and the fan blades extending therefrom produces an accelerated air stream, an annular splitter nose structure downstream of the fan configured to impinge the accelerated air stream and separate the accelerated air stream into a primary air stream and a secondary air stream, a core duct downstream of the splitter nose structure configured to receive and direct the primary air stream to a compressor section, a combustion section, and a turbine section, and a bypass duct downstream of the splitter nose structure configured to receive and direct the secondary air stream to an outlet. The splitter nose structure includes a radially inner surface configured to be contacted by the primary air stream, a radially outer surface configured to be contacted by the secondary air stream, and a midline therebetween. The splitter nose structure includes an irregular cross-sectional shape such that a first dimension between the midline and the radially inner surface is not equal to a second dimension between the midline and the radially outer surface. The first dimension and the second dimension are aligned, perpendicular to the rotational axis of the rotor, and pass through a point at which a curvature of the radially outer surface of the splitter nose structure is the same as an adjacent surface of the bypass duct.

An aircraft is provided that comprises a gas turbine engine including a fan section, a compressor section, a combustion section, and a turbine section. The fan section includes a rotor having a rotor hub rotatable about a rotational axis and a fan having a plurality of fan blades extending from the rotor hub and annularly spaced about the rotational axis, wherein rotation of the rotor hub and the fan blades extending therefrom is configured to produce an accelerated air stream. The aircraft includes an annular splitter nose structure downstream of the fan configured to impinge the accelerated air stream and separate the accelerated air stream into a primary air stream and a secondary air stream, wherein the splitter nose structure comprises a leading edge that is pitched radially outward relative to the rotational axis of the rotor hub at a pitch angle of between about 0.5 and 20 degrees, a core duct downstream of the splitter nose structure configured to receive and direct the primary air stream to the compressor section, the combustion section, and the turbine section, and a bypass duct downstream of the splitter nose structure configured to receive and direct the secondary air stream to an outlet.

Furthermore, other desirable features and characteristics of the gas turbine engines and the aircraft will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 is a schematic cross-sectional illustration of a gas turbine engine, which includes an exemplary splitter nose structure in accordance with the embodiments;

FIG. 2 is a detail cross-sectional view, taken at detail 2 of FIG. 1, which illustrates the splitter nose structure of FIG. 1 in accordance with various embodiments;

FIG. 3 is a cross-sectional view of a splitter nose structure having a circular cross-sectional shape;

FIG. 4 is a cross-sectional view of a splitter nose structure having an elliptical cross-sectional shape;

FIG. 5 is a cross-sectional view of a splitter nose structure having an irregular, elliptical-like cross-sectional shape that is pitched radially outward in accordance with various embodiments;

FIG. 6 is a flowchart illustrating a method of diverting air within a gas turbine engine in accordance with various embodiments.

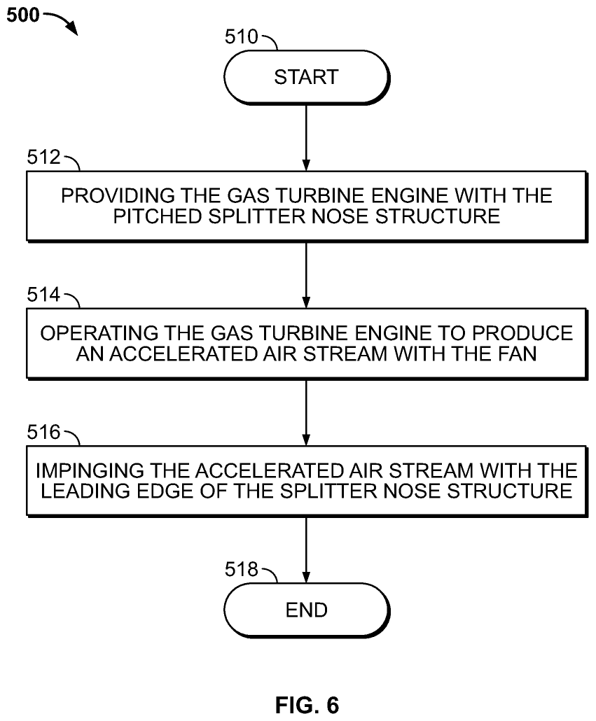

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

The following detailed description is merely exemplary in nature and is not intended to limit the application and uses. Furthermore, there is no intention to be bound by any expressed or implied theory presented in the preceding technical field, background, brief summary or the following detailed description. In addition, those skilled in the art will appreciate that embodiments of the present disclosure may be practiced in conjunction with any type of component for use in a gas turbine engine, and a splitter nose structure described herein for diverting air flow within a gas turbine engine is merely one exemplary embodiment according to the present disclosure. In addition, while the splitter nose structure is described herein as being used with a gas turbine engine onboard a mobile platform, such as an aircraft, the various teachings of the present disclosure can be used with a gas turbine engine on a stationary platform. Further, it should be noted that many alternative or additional functional relationships or physical connections may be present in an embodiment of the present disclosure. In addition, while the figures shown herein depict an example with certain arrangements of elements, additional intervening elements, devices, features, or components may be present in an actual embodiment. It should also be understood that the drawings are merely illustrative and may not be drawn to scale.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominately in the respective nominal axial or radial direction. As used herein, the term “transverse” denotes an axis that crosses another axis at an angle such that the axis and the other axis are neither substantially perpendicular nor substantially parallel.

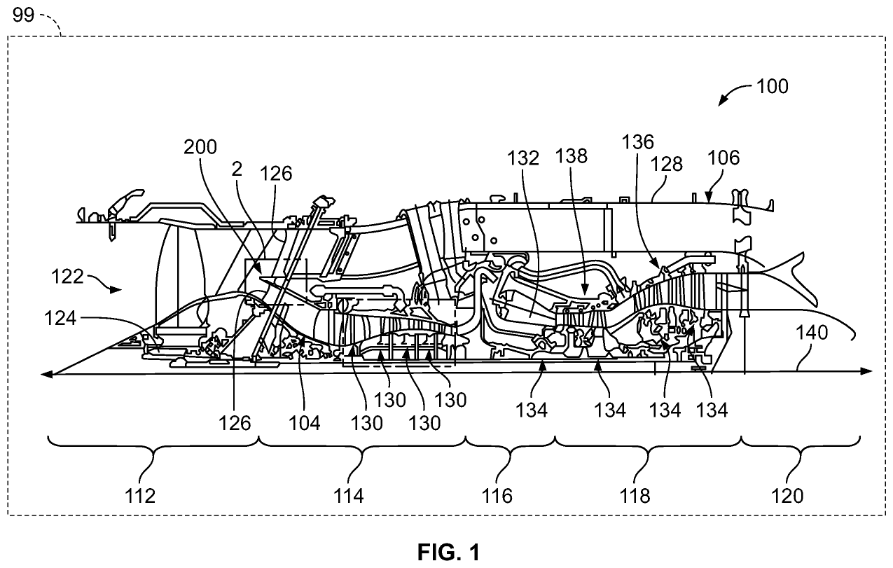

With reference to FIG. 1, a partial, cross-sectional view of an exemplary gas turbine engine 100 is shown with the remaining portion of the gas turbine engine 100 being substantially axisymmetric about a longitudinal axis 140, which also comprises an axis of rotation for the gas turbine engine 100. In the depicted embodiment, the gas turbine engine 100 is an annular multi-spool turbofan gas turbine jet engine within an aircraft 99, although other arrangements and uses may be provided.

In this example, with continued reference to FIG. 1, the gas turbine engine 100 includes a fan section 112, a compressor section 114, a combustor section 116, a turbine section 118, and an exhaust section 120. In one example, the fan section 112 includes a fan 122 having a plurality of fan blades annularly mounted on a rotor hub of a rotor 124 that draws air into the gas turbine engine 100 and compresses and/or accelerates the air into an air stream. A fraction of the air stream accelerated from the fan 122, referred to herein as a primary air stream, is directed through an inner core duct 104 into the compressor section 114 and the remaining fraction of air accelerated by the fan 122, referred to herein as a secondary air stream, is directed through an outer bypass duct 106 to an outlet.

In the embodiment of FIG. 1, the compressor section 114 includes one or more compressors 130. The number of compressors 130 in the compressor section 114 and the configuration thereof may vary. The one or more compressors 130 sequentially raise the pressure of the air and direct a majority of the high pressure air into the combustor section 116. A fraction of the compressed air bypasses the combustor section 116 and is used to cool, among other components, turbine blades in the turbine section 118.

In the embodiment of FIG. 1, in the combustor section 116, which includes a combustion chamber 132, the high pressure air is mixed with fuel, which is combusted. The high-temperature combustion air or combustive gas flow is directed into the turbine section 118. In this example, the turbine section 118 includes one or more turbines 134 disposed in axial flow series. It will be appreciated that the number of turbines 134, and/or the configurations thereof, may vary. The combustive gas expands through and rotates the turbines 134. The combustive gas flow then exits turbine section 118 for mixture with the cooler bypass airflow from the bypass duct 106 and is ultimately discharged from gas turbine engine 100 through exhaust section 120. As the turbines 134 rotate, each drives equipment in the gas turbine engine 100 via concentrically disposed shafts or spools. Generally, the turbines 134 in the turbine section 118, the compressors 130 in the compressor section 114 and the fan 122 are mechanically linked by one or more shafts or spools. For example, in a two spool turbofan engine platform, the turbine rotors contained within a high pressure (HP) turbine stage 136 may be rotationally fixed to the compressors 130 contained within compressor section 114 by a HP shaft, while the turbines 134 contained within a low pressure (LP) turbine stage 138 may be rotationally fixed to the rotor 124 of the fan 122 by a coaxial LP shaft. In other embodiments, gas turbine engine 100 may be a single spool engine or a multi-spool engine containing more than two coaxial shafts.

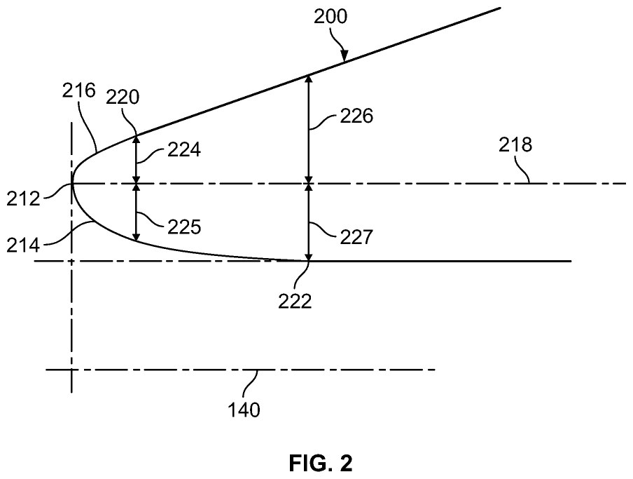

With reference to FIG. 2, a detail view of portions of the fan section 112 and the compressor section 114 at a transition therebetween is shown (detail 2 from FIG. 1). In the example of FIG. 2, the annular splitter nose structure 200 is configured to impinge the compressed air stream produced by the fan 122 and separate the compressed air stream into a primary air stream and a secondary air stream. The splitter nose structure 200 is supported by spaced apart rows of stator vanes 126 located between an inner wall of the splitter nose structure 200 and a core duct hub wall and similarly between an outer wall of the splitter nose structure 200 and a bypass duct shroud wall. The vanes 126 are in the bypass duct 106 and the core duct 104 downstream from a leading edge 212 of the splitter nose structure 200.

FIG. 2 presents a leading portion of the splitter nose structure 200 that includes radially outer surfaces 216 configured to divert air into the bypass duct 106 and radially inner surfaces 214 configured to divert air into the core duct 104. For convenience, the leading portion will be discussed herein with reference to a cross-sectional view thereof represented in the figures that is taken along a geometric plane that passes through and is aligned with the longitudinal axis 140 of the gas turbine engine 100. Further, the leading portion will be referred to as including an annular, longitudinal midline 218 that passes through the leading edge 212.

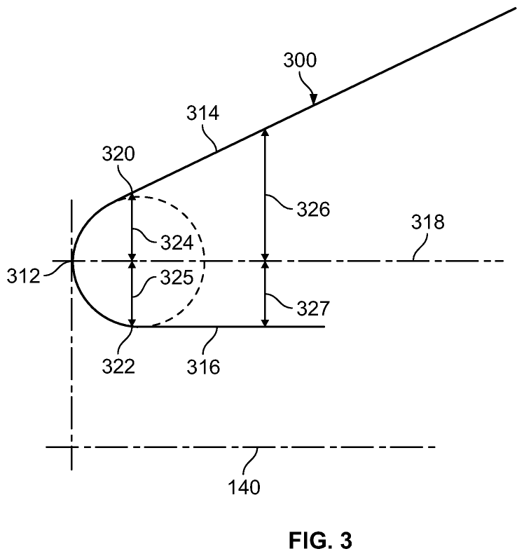

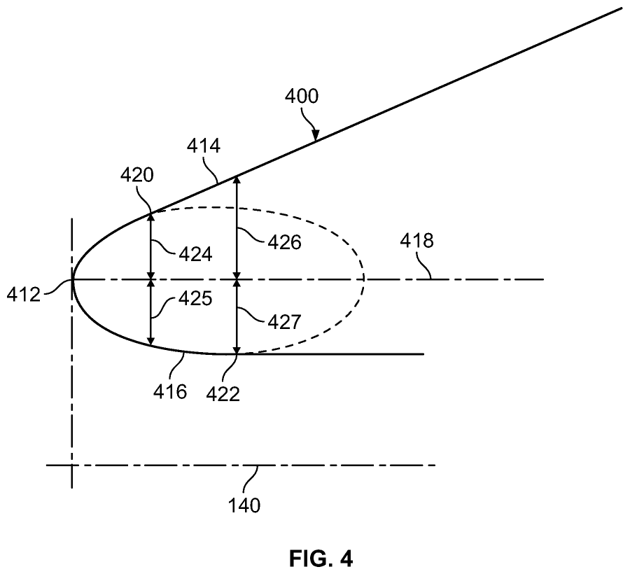

Conventionally, a leading edge of a splitter nose structure includes a circular or elliptical cross-sectional shape. In contrast, embodiments of the splitter nose structure 200 disclosed herein include the leading edge 212 having an irregular elliptical-like cross-sectional shape. FIGS. 3 and 4 present exemplary splitter nose structures including a circular splitter nose structure 300 having a leading edge 312 with a circular cross-sectional shape, an elliptical splitter nose structure 400 having a leading edge 412 with an elliptical cross-sectional shape.

As used herein, the cross-sectional shape of the leading edge 212 of the splitter nose structure 200 is referred to as “irregular” because geometric lines extending from the midline 218 of the leading portion (and within the geometric plane) to the radially outer surfaces 216 are not necessarily equal in dimension to geometric lines extending from corresponding points along the midline 218 to the radially inner surfaces 214. In contrast, geometric lines aligned along midline 218 of the circular splitter nose structure 300 and the elliptical splitter nose structure 400 of FIG. 3 may be equal.

For example, in FIGS. 2-4 exemplary aligned dimensions are presented for each example that are perpendicular to the longitudinal axis 140 of the gas turbine engine 100. In FIG. 2, dimensions 224 and 225 are oriented to pass through a first point 220 wherein a curvature of the radially outer surfaces 216 of the splitter nose structure 200 transitions into a slope and/or curvature corresponding to surfaces of the bypass duct 106, and dimensions 226 and 227 are oriented to pass through a second point 222 wherein a curvature of the radially inner surfaces 214 the splitter nose structure 200 transitions into a slope and/or curvature corresponding to surfaces of the core duct 104. In this example, the dimensions 224 and 225 are unequal and the dimensions 226 and 227 are unequal.

In FIG. 3, dimensions 324 and 325 are oriented to pass through a first point 320 wherein a curvature of the radially outer surfaces 316 of the splitter nose structure 300 transitions into a slope and/or curvature corresponding to surfaces of the bypass duct 106, and dimensions 326 and 327 are oriented to pass through a second point 322 wherein a curvature of the radially inner surfaces 314 the splitter nose structure 300 transitions into a slope and/or curvature corresponding to surfaces of the core duct 104. In this example, the dimensions 324 and 325 are equal and the dimensions 326 and 327 are unequal.

In FIG. 4, dimensions 424 and 425 are oriented to pass through a first point 420 wherein a curvature of the radially outer surfaces 416 of the splitter nose structure 400 transitions into a slope and/or curvature corresponding to surfaces of the bypass duct 106, and dimensions 426 and 427 are oriented to pass through a second point 422 wherein a curvature of the radially inner surfaces 414 the splitter nose structure 400 transitions into a slope and/or curvature corresponding to surfaces of the core duct 104. In this example, the dimensions 424 and 425 are equal and the dimensions 426 and 427 are unequal.

In various embodiments, the cross-sectional thickness of the splitter nose structure 200 as measured along dimensions perpendicular to the longitudinal axis 140 of the gas turbine engine 100 and between the radially outer surfaces 216 and the radially inner surfaces 214 does not increase at a constant rate from the leading edge toward the rear of the gas turbine engine 100 (e.g., the exhaust section 120), that is, the cross-sectional thickness non-uniformly increases.

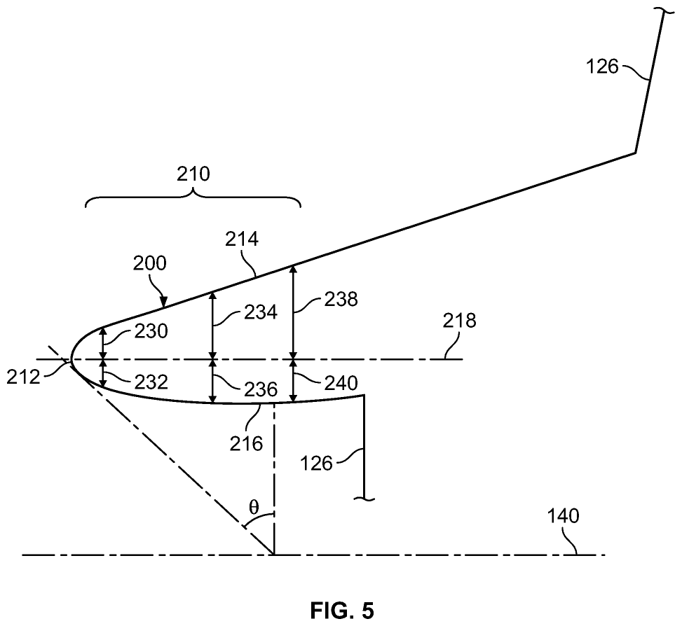

In various embodiments, surfaces of the gas turbine engine 100 downstream of the leading portion 210 may be substantially the same as with conventional gas turbine engines, that is, a slope and/or curvature of the downstream surfaces may be unaffected by the modifications to the cross-sectional shape of the leading portion 210. In other words, downstream portions of the splitter nose structure 200 (e.g., downstream of the leading portion 210 and/or downstream of an elliptical center of the cross-sectional shape) may be structured to smoothly transition into and with surfaces of the core duct 104 and the bypass duct 106. In some embodiments, this transition may require the cross-sectional thickness of a radially inner portion of the splitter nose structure 200, as measured between the midline 218 and the radially inner surfaces 216, to decrease and/or form a concave surface relative to the core duct 104. For example, FIG. 5 presents an example wherein the splitter nose structure 200 includes aligned dimensions 230/232, 234/236, and 238/240. The dimension 238 is greater than the dimension 234 and the dimension 234 is greater than the dimension 230. In contrast, the dimension 240 is less than the dimension 236 and the dimension 236 is greater than the dimension 232. As such, the cross-sectional thickness of the splitter nose structure 200, as measured between the midline 218 and the radially inner surfaces 216, have a decrease in dimension to accommodate a transition to the surfaces of the core duct 104.

In various embodiments, the splitter nose structure 200 may be pitched radially outward relative to the longitudinal axis 140 of the gas turbine engine 100. Referring to FIG. 5, the radially outward pitch of the splitter nose structure 200, represented herein by a pitch angle θ, may vary depending on the desired performance of the gas turbine engine 100. As used herein, the pitch angle θ is defined as an angle between the leading edge 212 or midline 218 of the splitter nose structure 200 and a line perpendicular to the longitudinal axis 140 of gas turbine engine 100. In general, it has been found that overall efficiency and efficiency of a core section (e.g., the compressor section 114, the combustor section 116, and the turbine section 118) of the gas turbine engine 100 may be improved by providing a positive pitch angle θ of between about 0.5 and 20 degrees, such as about 1 to 13 degrees, about 1.5 to 7 degrees, or about 2 to 4 degrees. In various embodiments, the pitch angle θ may be about 0.5 degrees, about 1.0 degrees, about 1.5 degrees, about 2.0 degrees, about 2.5 degrees, about 3.0 degrees, about 3.5 degrees, about 4.0 degrees, about 4.5 degrees, about 5.0 degrees, about 5.5 degrees, about 6.0 degrees, about 7.0 degrees, about 8.0 degrees, about 9.0 degrees, about 10.0 degrees, about 11.0 degrees, about 12.0 degrees, about 13.0 degrees, about 14.0 degrees, about 15.0 degrees, about 16.0 degrees, about 17.0 degrees, about 18.0 degrees, about 19.0 degrees, or about 20.0 degrees. In various embodiments, the pitch angle θ may be adjusted and/or optimized between about 0.5 and 20 degrees based on an angle of upstream air flow (e.g., downstream of the fan 122) relative to incidences of surfaces of the splitter nose structure 200.

In various embodiments, radial and/or longitudinal positions of the leading edge 212 of the splitter nose structure 200 within the gas turbine engine 100 may be substantially the same as conventional splitter nose structures. In other embodiments, the radial and/or longitudinal positions of the leading edge 212 may be adjusted to further modify the operating conditions of the gas turbine engine 100.

The gas turbine engines disclosed herein, including the gas turbine engine 100 having the splitter nose structure 200, provide for methods of directing air flow within the gas turbine engine 100 and thereby improving operational efficiency thereof. For example, FIG. 4 is a flow chart illustrating an exemplary method 500 for directing air flow within the gas turbine engine 100. The method 500 may start at 510.

At 512, the method 500 may include providing the gas turbine engine 100 having the fan section 112, the compressor section 114, the combustor section 116, and the turbine section 118. The fan section 112 includes the rotor 124 having the rotor hub and the fan 122 having the plurality of fan blades extending from the rotor hub and annularly spaced about the longitudinal axis 140. The splitter nose structure 200 within the gas turbine engine 100 includes the leading edge 212 thereof pitched radially outward relative to the longitudinal axis 140 at a pitch angle of between about 0.5 and 20 degrees. In various embodiments, providing the gas turbine engine 100 may include purchasing the gas turbine engine 100 commercially with the splitter nose structure 200 installed therein, purchasing a gas turbine engine commercially and installing the splitter nose structure 200, and/or building the gas turbine engine 100.

At 514, the method 500 may include operating the gas turbine engine 100 to rotate the rotor hub about the longitudinal axis 140 to produce the accelerated air stream with the plurality of fan blades. At 516, the method 500 may include impinging the accelerated air stream with the leading edge 212 of the splitter nose structure 200 and thereby separating the accelerated air stream into the primary air stream within the core duct 104 and the secondary air stream in the bypass duct 106. The method 500 may end at 518.

The gas turbine engines, the splitter nose structures, and the methods disclosed herein provide various benefits over certain existing systems and methods. For example, the pitched, elliptical-like cross-sectional shape of the splitter nose structure 200 promotes a reduction in aerodynamic losses that occur at the inlet of the core duct 104 and an increase in a pressure ratio across the fan 122.

In this document, relational terms such as first and second, and the like may be used solely to distinguish one entity or action from another entity or action without necessarily requiring or implying any actual such relationship or order between such entities or actions. Numerical ordinals such as “first,” “second.” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. A gas turbine engine comprising:
a fan section that includes a rotor having a rotor hub rotatable about a rotational axis and a fan having a plurality of fan blades extending from the rotor hub and annularly spaced about the rotational axis, wherein rotation of the rotor hub and the fan blades extending therefrom produces an accelerated air stream;
an annular splitter nose structure downstream of the fan configured to impinge the accelerated air stream and separate the accelerated air stream into a primary air stream and a secondary air stream, wherein the splitter nose structure comprises a leading edge that is pitched relative to a line perpendicular to the rotational axis of the rotor hub at a pitch angle of between about 0.5 and 20 degrees, wherein the splitter nose structure includes a radially inner surface configured to be contacted by the primary air stream, a radially outer surface configured to be contacted by the secondary air stream, and a midline therebetween that passes through the leading edge;
a core duct downstream of the splitter nose structure configured to receive and direct the primary air stream to a compressor section, a combustion section, and a turbine section; and
a bypass duct downstream of the splitter nose structure configured to receive and direct the secondary air stream to an outlet.

2. The gas turbine engine of claim 1, wherein the splitter nose structure includes an irregular cross-sectional shape such that a first dimension between the midline and the radially inner surface is not equal to a second dimension between the midline and the radially outer surface, wherein the first dimension and the second dimension are aligned, perpendicular to the rotational axis of the rotor, and pass through a point at which a curvature of the radially outer surface of the splitter nose structure is the same as an adjacent surface of the bypass duct.

3. The gas turbine engine of claim 1, wherein the splitter nose structure includes a lower portion having a varying cross-sectional thickness along dimensions extending between the midline and the radially inner surface and perpendicular to the rotational axis of the rotor that initially increases and then decreases in a direction from the leading edge of the splitter nose structure toward downstream surfaces thereof.

4. The gas turbine engine of claim 3, wherein the decrease in the cross-sectional thickness of the lower portion corresponds to a transition from the splitter nose structure to a surface of the core duct.

5. The gas turbine engine of claim 1, wherein the pitch angle of the leading edge of the splitter nose structure is between 0.5 and 7 degrees.

6. The gas turbine engine of claim 1, wherein the pitch angle of the leading edge of the splitter nose structure is between 2 and 4 degrees.

7. The gas turbine engine of claim 1, wherein the pitch angle of the leading edge of the splitter nose structure is about 3 degrees.

8. A gas turbine engine comprising:
a fan section that includes a rotor having a rotor hub rotatable about a rotational axis and a fan having a plurality of fan blades extending from the rotor hub and annularly spaced about the rotational axis, wherein rotation of the rotor hub and the fan blades extending therefrom produces an accelerated air stream;
an annular splitter nose structure downstream of the fan configured to impinge the accelerated air stream and separate the accelerated air stream into a primary air stream and a secondary air stream;
a core duct downstream of the splitter nose structure configured to receive and direct the primary air stream to a compressor section, a combustion section, and a turbine section; and
a bypass duct downstream of the splitter nose structure configured to receive and direct the secondary air stream to an outlet,
wherein the splitter nose structure includes a radially inner surface configured to be contacted by the primary air stream, a radially outer surface configured to be contacted by the secondary air stream, and a midline therebetween that passes through a leading edge of the splitter nose structure, wherein the splitter nose structure includes an irregular cross-sectional shape such that a first dimension between the midline and the radially inner surface is not equal to a second dimension between the midline and the radially outer surface, wherein the first dimension and the second dimension are aligned, perpendicular to the rotational axis of the rotor, and pass through a point at which a curvature of the radially outer surface of the splitter nose structure is the same as an adjacent surface of the bypass duct, wherein the splitter nose structure comprises the leading edge that is pitched relative to a line perpendicular to the rotational axis of the rotor hub at a pitch angle of between about 0.5 and 20 degrees.

9. The gas turbine engine of claim 8, wherein the splitter nose structure includes a lower portion having a varying cross-sectional thickness along dimensions extending between the midline and the radially inner surface and perpendicular to the rotational axis of the rotor that initially increases and then decreases in a direction from the leading edge of the splitter nose structure toward downstream surfaces thereof.

10. The gas turbine engine of claim 8, wherein the decrease in the cross-sectional thickness of the lower portion corresponds to a transition from the splitter nose structure to a surface of the core duct.

11. (canceled)

12. The gas turbine engine of claim 8, wherein the pitch angle is between about 0.5 and 7 degrees.

13. The gas turbine engine of claim 8, wherein the pitch angle is between about 2 and 4 degrees.

14. The gas turbine engine of claim 8, wherein the pitch angle is about 3 degrees.

15. An aircraft comprising:
a gas turbine engine including a fan section, a compressor section, a combustion section, and a turbine section;
a rotor within the fan section having a rotor hub rotatable about a rotational axis and a fan having a plurality of fan blades extending from the rotor hub and annularly spaced about the rotational axis, wherein rotation of the rotor hub and the fan blades extending therefrom is configured to produce an accelerated air stream;
an annular splitter nose structure downstream of the fan configured to impinge the accelerated air stream and separate the accelerated air stream into a primary air stream and a secondary air stream, wherein the splitter nose structure comprises a leading edge that is pitched relative to a line perpendicular to the rotational axis of the rotor hub at a pitch angle of between about 0.5 and 20 degrees, wherein the splitter nose structure includes a radially inner surface configured to be contacted by the primary air stream, a radially outer surface configured to be contacted by the secondary air stream, and a midline therebetween that passes through the leading edge;
a core duct downstream of the splitter nose structure configured to receive and direct the primary air stream to the compressor section, the combustion section, and the turbine section; and
a bypass duct downstream of the splitter nose structure configured to receive and direct the secondary air stream to an outlet.

16. The aircraft of claim 15, wherein the splitter nose structure includes an irregular cross-sectional shape such that a first dimension between the midline and the radially inner surface is not equal to a second dimension between the midline and the radially outer surface, wherein the first dimension and the second dimension are aligned, perpendicular to the rotational axis of the rotor, and pass through a point at which a curvature of the radially outer surface of the splitter nose structure is the same as an adjacent surface of the bypass duct.

17. The aircraft of claim 15, wherein the splitter nose structure includes a lower portion having a varying cross-sectional thickness along dimensions extending between the midline and the radially inner surface and perpendicular to the rotational axis of the rotor that initially increases and then decreases in a direction from the leading edge of the splitter nose structure toward downstream surfaces thereof.

18. The aircraft of claim 17, wherein the decrease in the cross-sectional thickness of the lower portion corresponds to a transition from the splitter nose structure to a surface of the core duct.

19. The aircraft of claim 15, wherein the pitch angle of the leading edge of the splitter nose structure is between 0.5 and 7 degrees.

20. The aircraft of claim 15, wherein the pitch angle of the leading edge of the splitter nose structure is between 2 and 4 degrees.
